(19) United States
(12) Patent Application Publication
(10) Pub. No.: US 2021/0246999 A1
(43) Pub. Date: Aug. 12, 2021

(54) RETAINERS

(71) Applicant: DAIWA KASEI KOGYO KABUSHIKI KAISHA, Okazaki-shi (JP)

(72) Inventor: Toru HONDA, Okazaki-shi (JP)

(21) Appl. No.: 16/986,698

(22) Filed: Aug. 6, 2020

(30) Foreign Application Priority Data
Feb. 12, 2020 (JP) 2020-021235

(51) Int. Cl. F16L 3/10; B60R 16/02

(52) U.S. Cl. CPC F16L 3/1075; B60R 16/0215

(57) ABSTRACT

A retainer may include a retainer body, a retainer cover connected to the retainer body via a hinge, a locking member configured to fasten the retainer body and the retainer cover with a cabling member clamped between the retainer body and the retainer cover, and protective portions formed in the retainer body or the retainer cover and configured to cover axial outer sides of the hinge. The protective portions are configured such that outer peripheries thereof are substantially positioned along outer end peripheries of the hinge as viewed in an axial direction of the hinge in a locking condition of the locking member.

### CROSS-REFERENCE TO RELATED APPLICATIONS

This application claims priority to a Japanese Patent Application serial number 2020-021235 filed Feb. 12, 2020, the contents of which are incorporated herein by reference.

### BACKGROUND

The present disclosure relates to a retainer. More specifically, the present disclosure relates to a retainer for protecting a cabling member distributed on an interior side of an automobile and the like.

Already known is an art in which a retainer is used to protect a cabling member such as a wiring harness distributed on an interior side of an automotive and the like. Such a retainer is taught by, for example, Japanese Laid-Open Patent Publication Number 2003-9344 (JP 2003-9344 A). As shown in FIG. 13(A) to FIG. 14(B), the retainer 201 taught therein includes a retainer body 210, a retainer cover 220 pivotally connected to the retainer body 210 via a hinge 230, and a locking member 240 that is configured to fasten the retainer body 210 and the retainer cover 220 with the cabling member clamped between an inner surface of the retainer body 210 and an inner surface of the retainer cover 220. Further, in the retainer 201 taught therein, the retainer body 210 includes protective portions 216 formed therein and configured to cover both axial outer sides of the hinge 230. Therefore, the hinge 230 may be prevented from suffering damage due to drop of the retainer 201 on a floor (not shown) or contact of the retainer 201 with other components (not shown).

However, in the art described above, as shown in a side view of the retainer 201 (FIG. 14(A) and FIG. 14(B)), in a locking condition of the locking member 240 (i.e., an engagement claw and an engagement slot (not shown)), the protective portions 216 may cover only a portion of the axial outer sides of the hinge 230. That is, uncovered hinge portions 216a that are not covered by the protective portions 216 may exist in the axial outer sides of the hinge 230. Therefore, the axial outer sides of the hinge 230 are not sufficiently protected.

Thus, there is a need in the art for improved retainers.

### SUMMARY

In one aspect of the present disclosure, a retainer may include a retainer body, a retainer cover connected to the retainer body via a hinge, a locking member configured to fasten the retainer body and the retainer cover with a cabling member clamped between the retainer body and the retainer cover, and protective portions formed in the retainer body or the retainer cover and configured to cover axial outer sides of the hinge. The protective portions are configured such that outer peripheries thereof are substantially positioned along outer end peripheries of the hinge as viewed in an axial direction of the hinge in a locking condition of the locking member.

According to this aspect, the outer end sides of the hinge may be completely covered by the protective portions. That is, the outer end sides of the hinge do not have any exposed portions that are not covered by the protective portions. As a result, the outer end sides of the hinge may be sufficiently protected. Further, the protective portions may prevent edges formed in the axial outer sides of the hinge from having a potential for harm.

In another aspect of the present disclosure, the locking member is configured to be locked in multiple locking stages, so that the retainer body and the retainer cover are fastened with either of a plurality of cabling members of different diameters clamped therebetween. The protective portions are configured such that the outer peripheries thereof are substantially positioned along the outer end peripheries of the hinge as viewed in the axial direction of the hinge in the locking condition of the locking member even when the locking member is locked in any of the locking stages.

According to this aspect, even when the locking member is locked in any of the locking stages, the outer peripheries of the protective portions are substantially positioned along the outer end peripheries of the hinge as viewed in the axial direction of the hinge. Therefore, even when the locking member is locked with either of the plurality of cabling members having different diameters clamped between the retainer body and the retainer cover, the outer end sides of the hinge may be sufficiently protected.

Additional objects, features and advantages of the present disclosure will be readily understood after reading the following detailed description together with the accompanying drawings and the claims.

### BRIEF DESCRIPTION OF THE DRAWINGS

FIG. 1 is a perspective view of a retainer according to a representative embodiment of the present disclosure, which illustrates an unlocking condition of a locking member;

FIG. 2 is a perspective view of the retainer shown in FIG. 1, which illustrates a locking condition of the locking member;

FIG. 3 is a perspective view of a first corrugated tube according to the representative embodiment;

FIG. 4 is a perspective view of a second corrugated tube according to the representative embodiment;

FIG. 5 is a perspective view of the retainer shown in FIG. 1, which illustrates one example of use conditions of the retainer;

FIG. 6 is an elevational view of FIG. 5;

FIG. 7 is a plan view of FIG. 5;

FIG. 8 is a side view of FIG. 5;

FIG. 9 is a perspective view of the retainer, which illustrates another example of the use conditions of the retainer;

FIG. 10 is an elevational view of FIG. 9;

FIG. 11 is a plan view of FIG. 9;

FIG. 12 is a side view of FIG. 9;

FIG. 13(A) is a side view of a conventional retainer, which illustrates an unlocking condition of a locking member;

FIG. 13(B) is a partially enlarged view of FIG. 13(A);

FIG. 14(A) is a perspective view of the retainer shown in FIG. 13(A), which illustrates a locking condition of the locking member; and

FIG. 14(B) is a partially enlarged view of FIG. 14(A).

### DETAILED DESCRIPTION

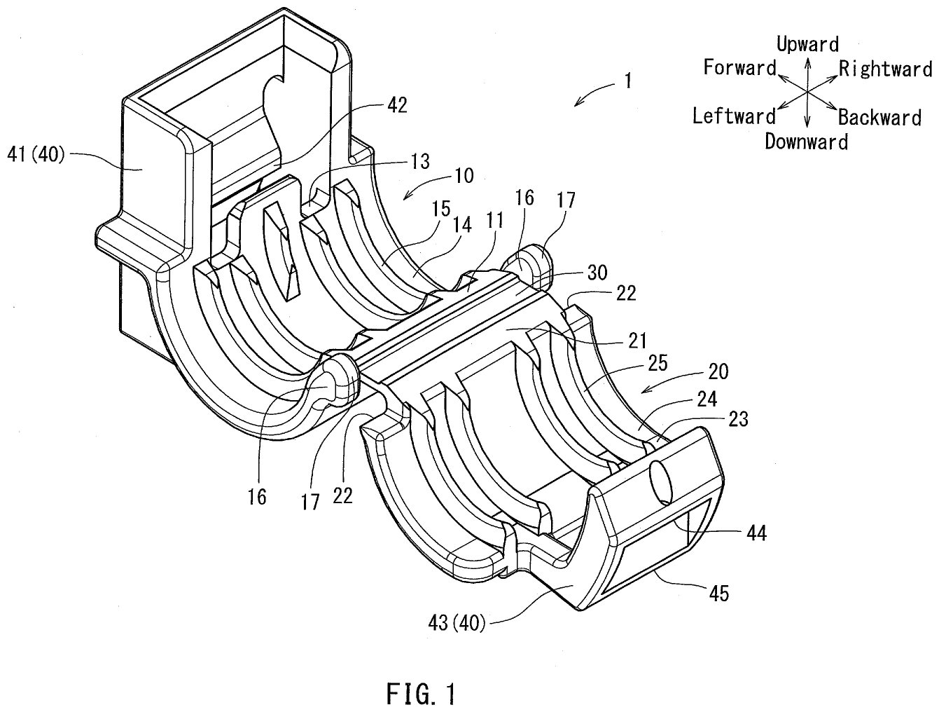

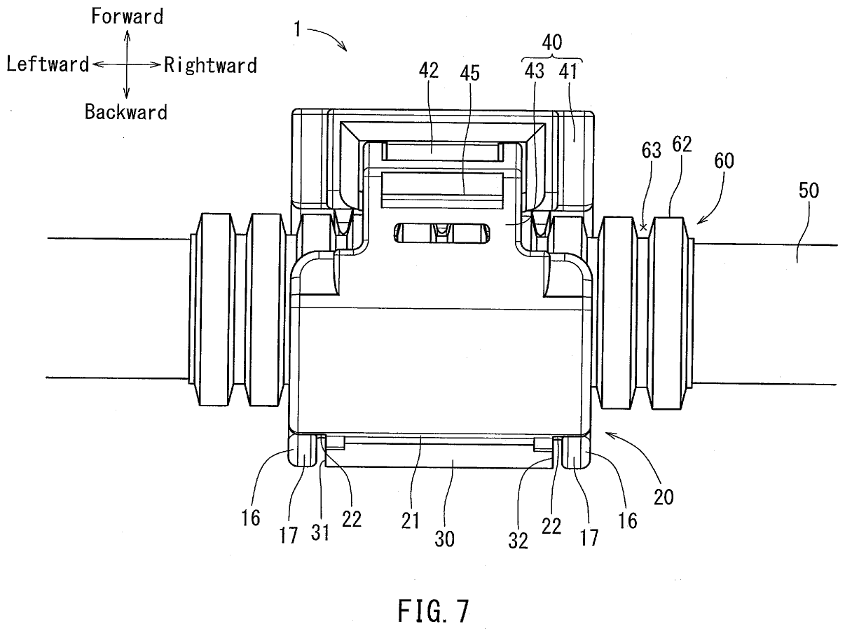

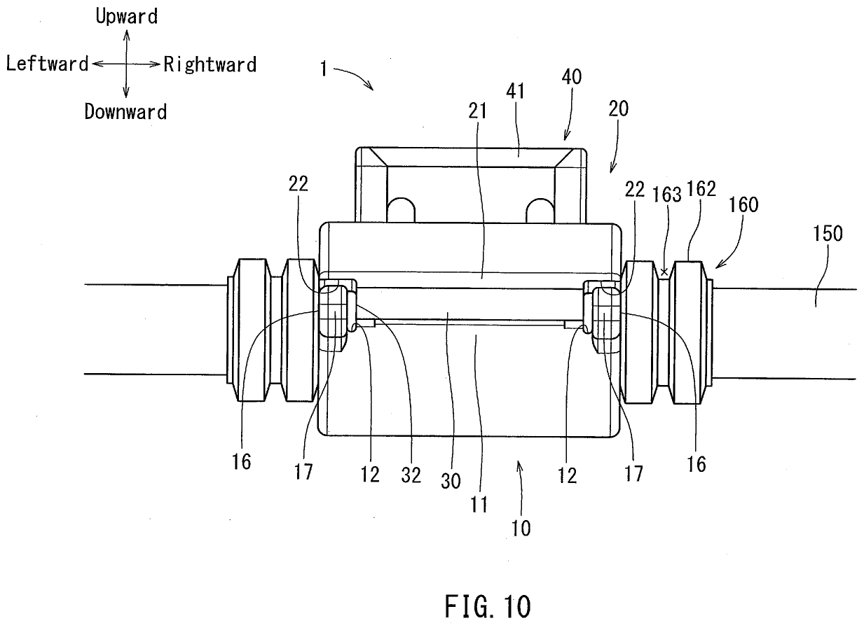

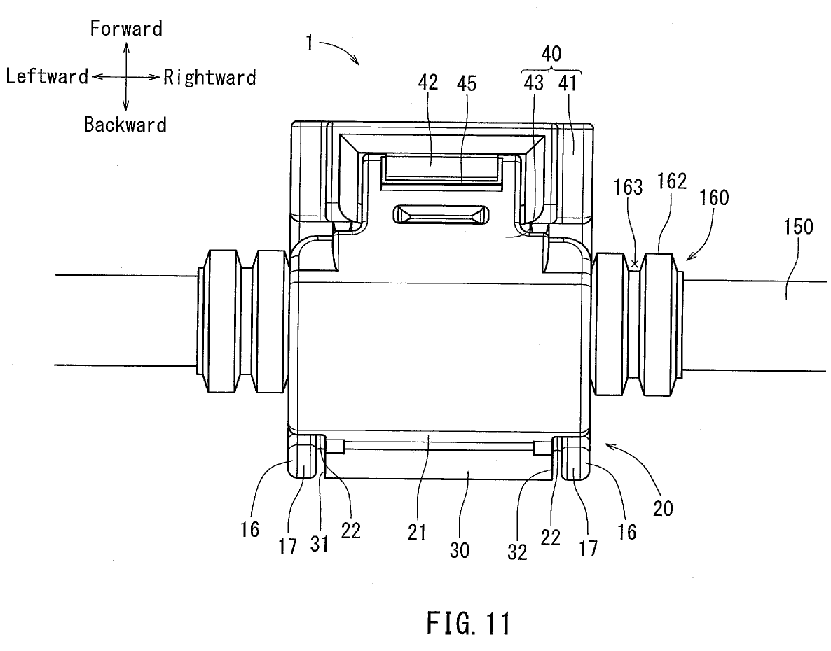

A detailed representative embodiment of the present disclosure is shown in FIGS. 1 to 12.

The present embodiment is directed to a retainer 1 that is configured to be commonly attached to two types of corrugated tubes having different diameters (a first corrugated tube 60 and a second corrugated tube 160). That is, the retainer 1 may be fastened while clamping either one of the first corrugated tube 60 and the second corrugated tube 160. Therefore, the retainer 1 may be configured to be fastened in two stages.

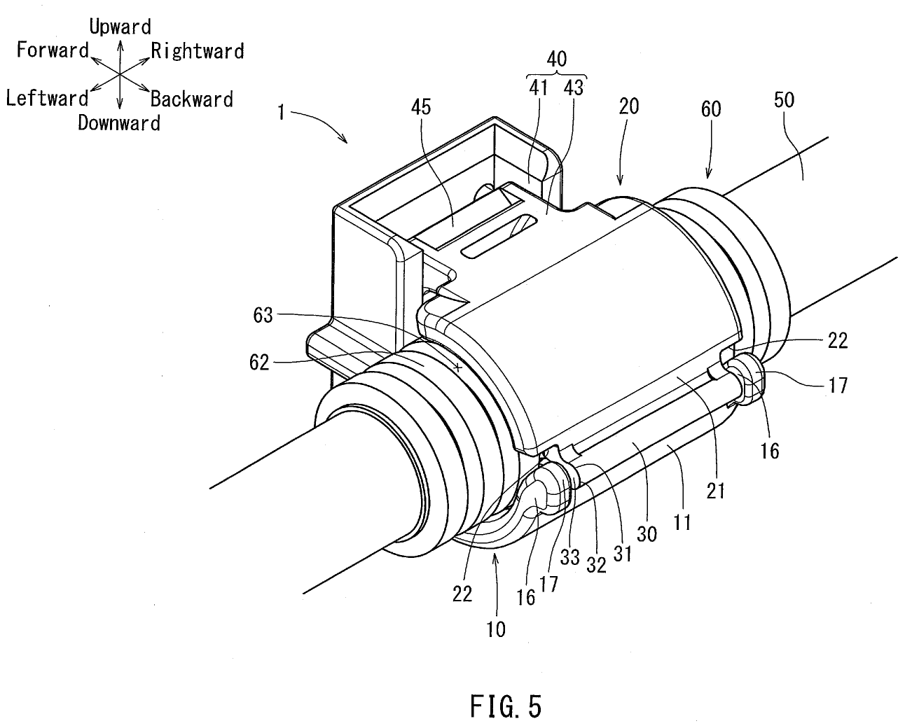

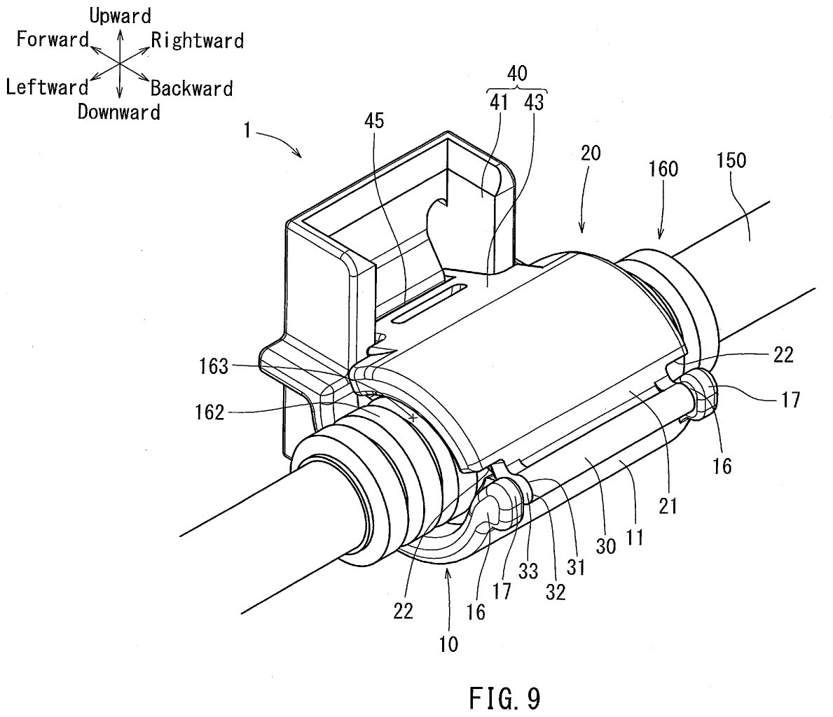

As shown in FIG. 5, the retainer 1 may be externally attached to the first corrugated tube 60 into which a first cabling member or wiring harness 50 is inserted. In other words, the retainer 1 may be attached to an outer circumferential surface 62 of the first corrugated tube 60. In particular, the retainer 1 may be fastened while clamping the first corrugated tube 60 into which the first wiring harness 50 is inserted. Further, as shown in FIG. 9, the retainer 1 may be externally attached to the second corrugated tube 160 into which a second cabling member or wiring harness 150 is inserted. In particular, the retainer 1 may be fastened while clamping the second corrugated tube 160 into which the second wiring harness 150 is inserted.

Next, the retainer 1, the first corrugated tube 60 and the second corrugated tube 160 will be hereinafter described. Further, forward, backward, rightward, leftward, upward and downward directions described with reference to the figures may be defined simply for descriptive purposes.

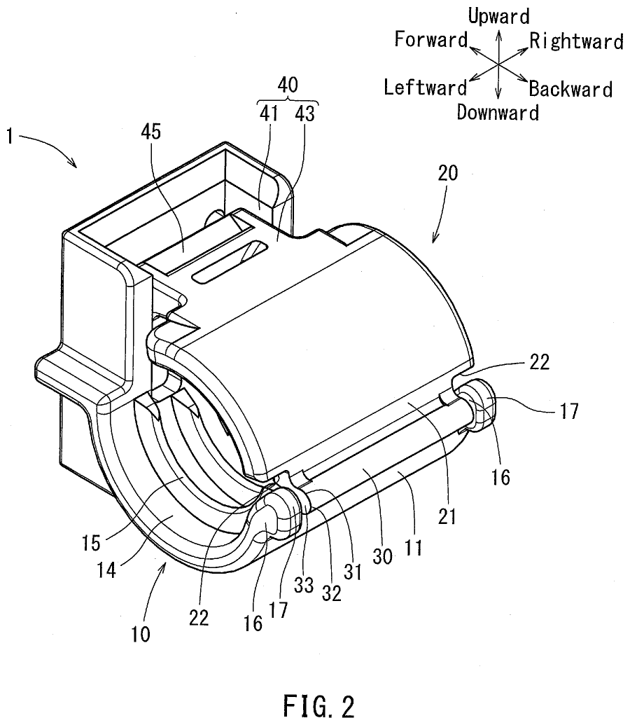

First, as shown in FIGS. 1 and 2, the retainer 1 may include a retainer body 10, and a retainer cover 20 rotatably or pivotally connected to the retainer body 10 via a hinge 30 that extends in a lateral (right and left) or axial direction of the retainer body 10. The retainer 1 may further include a locking member 40 that is configured to fasten the retainer body 10 and the retainer cover 20 with each of the first corrugated tube 60 and the second corrugated tube 160 clamped between the retainer body 10 and the retainer cover 20. Further, the retainer body 10 and the retainer cover 20 may substantially be formed as a pair of halved cylindrical members, which are pivotally connected to each other via the hinge 30.

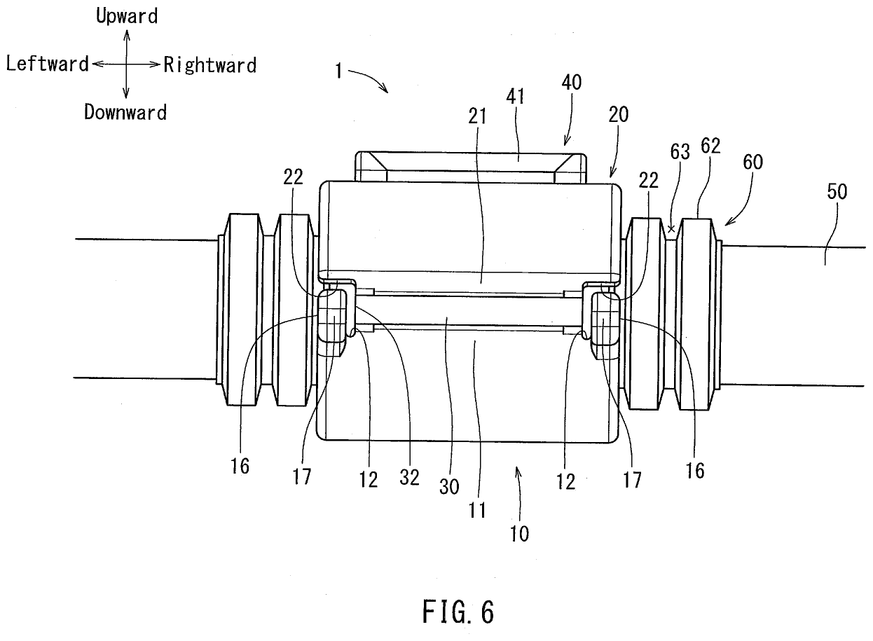

The retainer body 10 may have a substantially half-cylindrical gutter shape. The retainer body 10 may have a proximal or first end periphery 11 and a distal or second end periphery 13 positioned opposite to each other and respectively extending in the lateral or axial direction thereof. The first end periphery 11 may be a portion in which the hinge 30 is formed therealong. Further, the retainer body 10 may have removed portions 12 (FIG. 6) formed in right and left (lateral) end portions of the first end periphery 11. Also, the retainer body 10 may have a plurality of ribs 15 formed in a half-round inner surface 14 thereof and positioned at certain intervals in the axial direction thereof

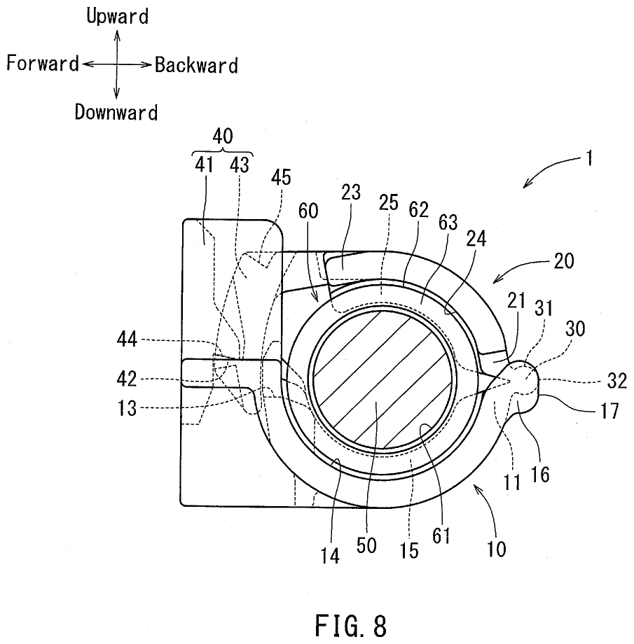

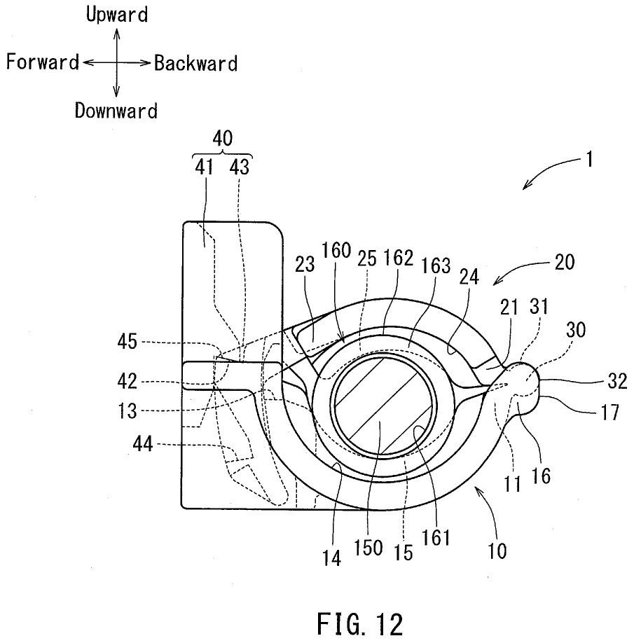

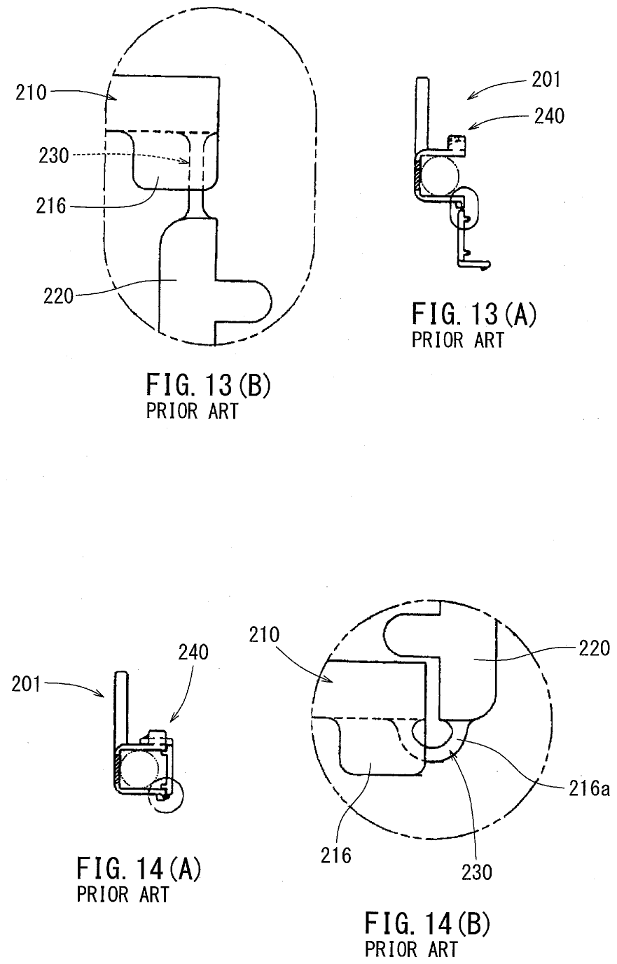

The retainer body 10 may have protective portions 16 respectively formed in the right and left end portions thereof and projected into the removed portions 12 formed in the first end periphery 11. As shown in FIGS. 8 and 12, the protective portions 16 may respectively be configured to overhang or cover axial outer sides (surfaces) 33 of the hinge 30 in two retainer fastening conditions in which the retainer body 10 and the retainer cover 20 are closed and fastened in two (fastened) stages, which will be hereinafter described. In particular, the protective portions 16 may respectively be configured such that circumferences or outer peripheries 17 thereof may substantially be positioned along (axial) outer end peripheries 31 of the hinge 30 (i.e., such that outlines thereof may substantially correspond to profiles of the axial outer sides 33 of the hinge 30) as viewed in a lateral or axial direction of the hinge 30 (which corresponds to the axial direction of the retainer body 10) in each of the two retainer fastening conditions. Preferably, the protective portions 16 may respectively be configured such that the outer peripheries 17 thereof may be positioned closely adjacent to the outer end peripheries 31 of the hinge 30 as viewed in the lateral or axial direction of the hinge 30. Further, the two retainer fastening conditions may correspond to two locking conditions of the locking member 40, which will be hereinafter described.

The retainer cover 20 may have a substantially half-cylindrical gutter shape. The retainer cover 20 may have a proximal or first end periphery 21 and a distal or second end periphery 23 positioned opposite to each other and respectively extending in a lateral or axial direction thereof (which corresponds to the axial direction of the retainer body 10). The first end periphery 21 may be a portion in which the hinge 30 is formed therealong. Further, the retainer cover 20 may have removed portions 22 formed in right and left (lateral) end portions of the first end periphery 21. The removed portions 22 may be configured to prevent the retainer cover 20 from interfering with the protective portions 16 formed in the retainer body 10 when the retainer cover 20 is rotated relative to the retainer body 10 about the hinge 30. Also, the retainer cover 20 may have a plurality of ribs 25 formed in a half-rounded inner surface 24 thereof and positioned at certain intervals in the axial direction thereof. Further, the ribs 25 may preferably be configured to be opposite to the ribs 15 formed in the retainer body 10 when the retainer body 10 and the retainer cover 20 are closed.

The locking member 40 may be composed of a locking block 41 formed in the second end periphery 13 of the retainer body 10 and a locking strip 43 formed in the second end periphery 23 of the retainer cover 20. The locking block 41 may have an engagement claw 42 formed therein. Conversely, the locking strip 43 may have first and second engaging claws 44 and 45 formed therein. As shown in FIGS. 8 and 12, the first and second engagement claws 44 and 45 may be positioned stepwise in a rotational direction of the retainer cover 20 relative to the retainer body 10. That is, the locking member 40 may be locked in two (multiple) locking stages.

Further, the first and second engaging claws 44 and 45 may respectively be configured to separately engage the engagement claw 42 of the locking block 41 depending on degrees of rotation of the retainer cover 20. In particular, as shown in FIG. 8, the first engaging claw 44 may be configured to engage the engagement claw 42 of the locking block 41 when the retainer body 10 and the retainer cover 20 are closed while clamping the first corrugated tube 60 between the inner surface 14 of the retainer body 10 and the inner surface 24 of the retainer cover 20. Upon engagement of the first engaging claw 44 and the engagement claw 42, the locking member 40 is locked in a first locking stage (which may be referred to as a first locking condition of the locking member 40), so that the retainer body 10 and the retainer cover 20 may be closed and fastened while clamping the first corrugated tube 60 therebetween (which may be referred to as a first retainer fastening condition).

Conversely, as shown in FIG. 12, the second engaging claw 45 may be configured to engage the engagement claw 42 of the locking block 41 when the retainer body 10 and the retainer cover 20 are closed while clamping the second corrugated tube 160 between the inner surface 14 of the retainer body 10 and the inner surface 24 of the retainer cover 20. Upon engagement of the second engaging claw 45 and the engagement claw 42, the locking member 40 is locked in a second locking stage (which may be referred to as a second locking condition of the locking member 40), so that the retainer body 10 and the retainer cover 20 may be closed and fastened while clamping the second corrugated tube 160 therebetween (which may be referred to as a second retainer fastening condition).

Thus, the locking member 40 may be locked in two locking stages. Therefore, the retainer 1 may be fastened while clamping either one of the first corrugated tube 60 and the second corrugated tube 160 having different diameters. Further, the retainer 1 may preferably be formed as an integral part of the retainer body 10, the retainer cover 20 and the locking member 40, for example by molding a hard synthetic resin.

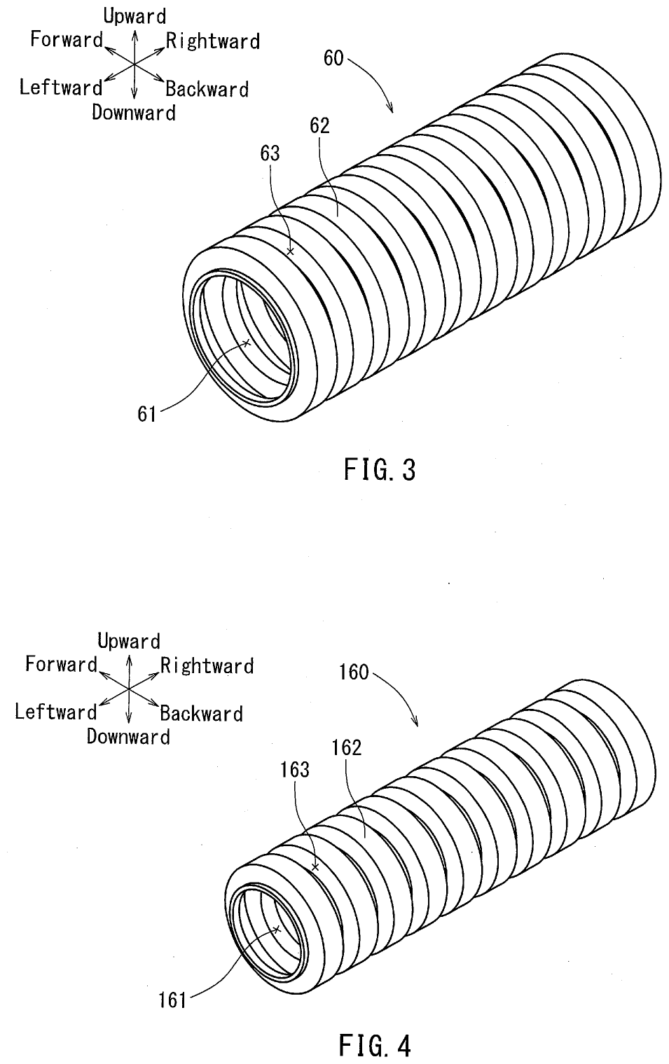

In this embodiment, the first and second corrugated tubes 60 and 160 may respectively have the substantially same structures with the exception of their diameters. The first corrugated tube 60 may have a relatively large diameter. As shown in FIG. 3, the first corrugated tube 60 may be formed as a cylindrical tubular member and configured such that the first wiring harness 50 is inserted into an inner bore 61 thereof. Further, the first corrugated tube 60 may preferably have an inner diameter slightly smaller than an outer diameter of the first wiring harness 50. Therefore, the first wiring harness 50 inserted into the inner bore 61 of the first corrugated tube 60 may be prevented from (laterally) moving within the inner bore 61.

The first corrugated tube 60 may have a plurality of annular engagement grooves 63 that are formed in an outer circumferential surface 62 thereof at certain intervals in an axial direction of the first corrugated tube 60. The plurality of engagement grooves 63 may be configured such that the plurality of ribs 15 formed in the retainer body 10 and the plurality of ribs 25 formed in the retainer cover 20 may fit thereinto. Therefore, when the retainer body 10 and the retainer cover 20 are closed and fastened in a condition in which the first corrugated tube 60 is clamped between the inner surface 14 of the retainer body 10 and the inner surface 24 of the retainer cover 20, the first corrugated tube 60 may be prevented from (laterally) moving relative to the retainer 1.

The second corrugated tube 160 may have a relatively small diameter, i.e., a diameter smaller than the diameter of the first corrugated tube 60. As shown in FIG. 4, the second corrugated tube 160 may be formed as a cylindrical tubular member and configured such that the second wiring harness 150 having a diameter smaller than the first wiring harness 50 is inserted into an inner bore 161 thereof. Further, the second corrugated tube 160 may preferably have an inner diameter slightly smaller than an outer diameter of the second wiring harness 150. Therefore, the second wiring harness 150 inserted into the inner bore 161 of the second corrugated tube 160 may be prevented from (laterally) moving within the inner bore 161.

The second corrugated tube 160 may have a plurality of annular engagement grooves 163 that are formed in an outer circumferential surface 162 thereof at certain intervals in an axial direction of the second corrugated tube 160. The plurality of engagement grooves 163 may be configured such that the plurality of ribs 15 formed in the retainer body 10 and the plurality of ribs 25 formed in the retainer cover 20 may fit thereinto. Therefore, when the retainer body 10 and the retainer cover 20 are closed and fastened in a condition in which the second corrugated tube 160 is clamped between the inner surface 14 of the retainer body 10 and the inner surface 24 of the retainer cover 20, the second corrugated tube 160 may be prevented from (laterally) moving relative to the retainer 1.

A representative method for attaching the retainer 1 to the first and second corrugated tubes 60 and 160 will now be described.

In order to attach the retainer 1 to the first (large diameter) corrugated tube 60 into which the first wiring harness 50 is inserted (which may be referred to as a first attaching operation), first, the first wiring harness 50 may be inserted into the inner bore 61 of the first corrugated tube 60 shown in FIG. 3, which may be referred to as a first process. That is, the first wiring harness 50 may be externally fitted with the first corrugated tube 60. Subsequently, the first corrugated tube 60 externally fitted onto the first wiring harness 50 may be set on the inner surface 14 of the retainer body 10 in a retainer open condition shown in FIG. 1, which may be referred to as a second process.

At this time, the first corrugated tube 60 may be appropriately positioned such that the plurality of ribs 15 formed in the retainer body 10 fit into the plurality of engagement grooves 63 of the first corrugated tube 60, which may be referred to as a third process. Subsequently, the retainer cover 20 may be rotated about the hinge 30, so as to close the retainer body 10 and the retainer cover 20, which may be referred to as a fourth process. At this time, the retainer cover 20 may be adjusted such that the plurality of ribs 25 formed in the retainer cover 20 fit into the plurality of engagement grooves 63 of the first corrugated tube 60, which may be referred to as a fifth process.

Further, the retainer cover 20 may be rotated until the first engaging claw 44 engages the engagement claw 42 of the locking block 41 (FIGS. 5 to 8), i.e., until the locking member 40 reaches the first locking condition, which may be referred to as a sixth process. As a result, the retainer body 10 and the retainer cover 20 (the retainer 1) may be closed and fastened by the locking member 40 while the first corrugated tube 60 into which the first wiring harness 50 is inserted is clamped therebetween. Thus, the retainer 1 may be externally attached to the first corrugated tube 60 that is externally fitted onto the first wiring harness 50. As shown in FIG. 8, in this condition, i.e., in the first retainer fastening condition (the first locking condition of the locking member 40), the outer peripheries 17 of the protective portions 16 formed in the retainer body 10 may substantially be positioned along the outer end peripheries 31 of the hinge 30 as viewed in the axial direction of the retainer body 10 (i.e., as viewed in the axial direction of the hinge 30).

Conversely, in order to attach the retainer 1 to the second (small diameter) corrugated tube 160 into which the second wiring harness 150 is inserted (which may be referred to as a second attaching operation), the first to sixth processes may be performed in the same manner as the first attaching operation. However, in the sixth process of the second attaching operation, the retainer cover 20 may be rotated until the second engaging claw 45 engages the engagement claw 42 of the locking block 41 (FIGS. 9 to 12), i.e., until the locking member 40 reaches the second locking condition. As a result, the retainer body 10 and the retainer cover 20 (the retainer 1) may be closed and fastened by the locking member 40 while the second corrugated tube 160 into which the second wiring harness 150 is inserted is clamped therebetween. Thus, the retainer 1 may be externally attached to the second corrugated tube 160 that is externally fitted onto the second wiring harness 150. As shown in FIG. 12, in this condition, i.e., in the second retainer fastening condition (the second locking condition of the locking member 40), similar to the first retainer fastening condition, the outer peripheries 17 of the protective portions 16 formed in the retainer body 10 may substantially be positioned along the outer end peripheries 31 of the hinge 30 as viewed in the axial direction of the retainer body 10 (i.e., as viewed in the axial direction of the hinge 30).

As described above, the retainer 1 may be configured such that the retainer body 10 and the retainer cover 20 are closed and fastened while clamping either of the first and second corrugated tubes 60 and 160 having different diameters therebetween. That is, the locking member 40 may be configured to be locked in two stages while either of the first and second corrugated tubes 60 and 160 having different diameters is clamped between the retainer body 10 and the retainer cover 20. Therefore, the retainer 1 may be commonly attached to both of the first and second corrugated tubes 60 and 160 having different diameters.

According to the retainer 1 of the present embodiment described above, in one locking condition (the first locking condition) of the locking member 40, the outer peripheries 17 of the protective portions 16 formed in the retainer body 10 may substantially be positioned along the outer end peripheries 31 of the hinge 30 as viewed in the axial direction of the retainer body 10 (i.e., as viewed in the axial direction of the hinge 30). Therefore, in the first locking condition of the locking member 40, the axial outer sides 33 of the hinge 30 may be completely covered by the protective portions 16. In other words, the axial outer sides 33 of the hinge 30 may not have any exposed portions that are not covered by the protective portions 16. As a result, the axial outer sides 33 of the hinge 30 may be sufficiently protected. Further, a potential for harm by edges 32 formed in the axial outer sides 33 of the hinge 30 may be prevented by the protective portions 16.

Similarly, in another locking condition (the second locking condition) of the locking member 40, the outer peripheries 17 of the protective portions 16 formed in the retainer body 10 may substantially be positioned along the outer end peripheries 31 of the hinge 30 as viewed in the axial direction of the retainer body 10 (i.e., as viewed in the axial direction of the hinge 30). Therefore, in the second locking condition of the locking member 40, the axial outer sides 33 of the hinge 30 may be completely covered by the protective portions 16. As a result, the axial outer sides 33 of the hinge 30 may be sufficiently protected.

Naturally, various changes and modifications may be made to the present disclosure without departing from the scope of the disclosure. For example, in the retainer 1, the protective portions 16 are formed in the retainer body 10. However, the protective portions 16 may be formed in the retainer cover 20. Alternatively, instead of forming the protective portions 16 in the retainer body 10 or the retainer cover 20, the retainer body 10 and/or the retainer cover 20 may be configured to cover the axial outer sides 33 of the hinge 30 in the retainer fastening conditions in which the retainer body 10 and the retainer cover 20 are closed and fastened, i.e., in the locking conditions of the locking member 40. Further, the hinge 30 is formed as a laterally elongated continuous member. However, the hinge 30 may be formed as a discontinuous hinge unit composed of a plurality of hinge parts that are laterally separately positioned. In such a case, the protective portions 16 may be formed in the retainer body 10 (the retainer cover 20) so as to cover outer end sides of the outermost hinge parts. Further, the retainer body 10 and the retainer cover 20 are formed as a pair of halved cylindrical members. However, the retainer body 10 and the retainer cover 20 may be formed as a pair of halved rectangular cylindrical members.

Further, the retainer 1 is configured to be externally attached to either of the first and second corrugated tubes 60 and 160 into which the first and second wiring harnesses 50 and 150 are respectively inserted. However, the retainer 1 may be configured to be directly attached to either of the first and second wiring harnesses 50 and 150 without using the first and second corrugated tubes 60 and 160. That is, the retainer body 10 and the retainer cover 20 may be configured to be closed and fastened while directly clamping either of the first and second wiring harnesses 50 and 150 therebetween. Further, in the embodiment, the wiring harnesses are exemplified as the cabling member. However, the cabling member may be various types of hoses or other such members.

Further, in the embodiment, the retainer 1 (the retainer body 10 and the retainer cover 20) is configured to be closed and fastened, e.g., while clamping either of two corrugated tubes (either of the first and second corrugated tubes 60 and 160) having different diameters therebetween. However, the retainer 1 may be configured to be closed and fastened, e.g., while clamping any of three, four or more corrugated tubes having different diameters therebetween. In such a case, the locking member 40 may be changed so as to be locked in three, four or more (multiple) locking stages.

A representative example of the present disclosure has been described in detail with reference to the attached drawings. This detailed description is merely intended to teach a person of skill in the art further details for practicing preferred aspects of the present disclosure and is not intended to limit the scope of the disclosure. Only the claims define the scope of the claimed disclosure. Therefore, combinations of features and steps disclosed in the foregoing detailed description may not be necessary to practice the disclosure in the broadest sense, and are instead taught merely to particularly describe detailed representative examples of the disclosure. Moreover, the various features taught in this specification may be combined in ways that are not specifically enumerated in order to obtain additional useful embodiments of the present disclosure.

What is claimed is:

1. A retainer, comprising:
a retainer body;
a retainer cover connected to the retainer body via a hinge;
a locking member configured to fasten the retainer body and the retainer cover with a cabling member clamped between the retainer body and the retainer cover; and
protective portions formed in the retainer body or the retainer cover and configured to cover axial outer sides of the hinge,
wherein the protective portions are configured such that outer peripheries thereof are substantially positioned along outer end peripheries of the hinge as viewed in an axial direction of the hinge in a locking condition of the locking member.

2. The retainer as described in claim 1, wherein the locking member is configured to be locked in multiple locking stages, so that the retainer body and the retainer cover are fastened with either of a plurality of cabling members of different diameters clamped therebetween, and
wherein the protective portions are configured such that the outer peripheries thereof are substantially positioned along the outer end peripheries of the hinge as viewed in the axial direction of the hinge in the locking condition of the locking member even when the locking member is locked in any of the locking stages.

3. A retainer, comprising:
a retainer body;
a retainer cover; and
a hinge configured to connect the retainer cover to the retainer body,
wherein the retainer body or the retainer cover is configured to cover axial outer sides of the hinge in a retainer fastening condition in which the retainer body and the retainer cover are fastened.

4. The retainer as described in claim 3, wherein the retainer body or the retainer cover has protective portions formed therein, and wherein the protective portions are configured such that outer peripheries thereof are positioned adjacent to the axial outer end peripheries of the hinge in the retainer fastening condition.

5. The retainer as described in claim 4 further comprising a locking member that is configured to be locked in multiple locking stages such that the retainer body and the retainer cover are fastened in multiple fastened stages, wherein the protective portions are configured such that the outer peripheries thereof are positioned adjacent to the axial outer end peripheries of the hinge even when the retainer body and the retainer cover are fastened in any of the fastened stages.

6. The retainer as described in claim 4, wherein the retainer body has removed portions formed therein, and wherein the protective portions are formed in the retainer body and are respectively configured to be positioned within the removed portions.
